(19) United States
(12) Patent Application Publication
(10) Pub. No.: US 2010/0095844 A1
(43) Pub. Date: Apr. 22, 2010

(54) Portable room air purifier

(75) Inventors: Kenneth E. Gilleland, Long Beach, CA (US); Robert M. Culbert, Manhattan Beach, CA (US); Robert Scheir, Sherman Oaks, CA (US)

Correspondence Address: ROTHWELL, FIGG, ERNST & MANBECK, P.C., 1425 K STREET, N.W., SUITE 800, WASHINGTON, DC, 20005, US

(73) Assignee: Steril-Aire, Inc., Burbank, CA (US)

(21) Appl. No.: 12/289,039

(22) Filed: Oct. 17, 2008

(51) Int. Cl. B01D 50/00; B03C 3/38; B01D 53/02

(52) U.S. Cl. 95/148; 96/224; 96/16; 95/90

(57) ABSTRACT

A portable room air purifier includes a hollow cylindrical air filter disposed within a housing and having an inner surface circumscribing a cylindrical air treatment space and an outer surface. A sorbant material is disposed on the inner surface of the air filter and a germicidal lamp is disposed within the cylindrical air treatment space to emit germicidal light within the space and incident upon the sorbant material on the inner surface of the air filter. A fan is disposed in the housing to draw air from the cylindrical air treatment space through the air filter such that the air enters the filter through the inner surface and exits the filter through the outer surface. The portable room air purifier preferably includes an electrical circuit configured to power the fan and the germicidal lamp when the housing is in an assembled condition, and to deactivate both the fan and the lamp when the housing is disassembled.

### BACKGROUND OF THE INVENTION

I. Field of the Invention

The present invention relates generally to air purification systems and, more particularly, to a portable room air purifier for use in residential buildings, offices and the like.

II. Discussion of the Background Art

Homeowners and office workers are increasingly concerned about the impact of indoor air quality on their health and well-being. Pollutants, such as dust, pollen, pet dander and mold, can trigger allergic reactions, asthma and other maladies in some people. Volatile organic compounds (VOCs) can create undesirable odors and can also trigger allergic reactions. Additionally, airborne microorganisms, such as bacteria and viruses, can cause colds, flu and other infectious ailments.

Standard air conditioning and heating systems are not effective in removing these harmful airborne pollutants, so people have turned to portable room air purifiers in an effort to improve indoor air quality in their homes and offices. There are several different types of portable room air purifiers currently available. Most involve use of a filter, activated carbon, an ionizer, an ozone generator or a photocatalytic oxidation (PCO) devices.

Filter-based air purifiers remove solid particles from air by trapping the particles in a filter matrix having a pore size smaller than the particles. These units typically include a fan that draws air through the filter to capture airborne particles. A disadvantage of filter-based air purifiers is that they are generally unable to trap VOCs, microorganisms, and particles smaller than about 0.01 microns. Additionally, the filters in these purifiers are often positioned without an air tight seal, allowing air to pass around the filter without being filtered. Activated carbon is sometimes used in combination with a filter in some air purifiers to absorb volatile chemicals, but does not eliminate microorganisms or ensure an air tight seal. Over time, activated carbon loses its ability to absorb volatile chemicals and must be replaced more frequently than is desirable.

Another type of portable room air purifier, referred to as an ionizer, uses charged electrical surfaces to generate electrically charged ions that attach to airborne particles which are then electrostatically attracted to a charged collector plate. This ionizing process produces ozone as a by-product, the dangers of which are well-documented and may include coughing, throat irritation, wheezing, lung damage, and aggravation of asthma and other respiratory ailments The American Lung Association states that “exposure to ozone causes a variety of adverse health effects, even at levels below the current standard.” Additionally, some of these ionizing air purifiers lack a fan and are thus unable to efficiently purify large amounts of air.

Ozone generators are yet another type of portable room air purifier. These purifiers produce significant amounts of ozone, a strong oxidant gas, to oxidize noxious airborne chemicals. However, as noted above, ozone is harmful in large amounts, so the only safe use of ozone generators is in unoccupied rooms.

Photocatalytic oxidation (PCO) air purifiers use ultraviolet light to oxidize and degrade organic contaminants. It has been found that ultraviolet energy having a wavelength of 260 nm (UVC) targets the DNA of microorganisms, causing cell death or making replication impossible. The UVC energy kills or inactivates microbes, eradicating airborne mold, as well as viruses and bacteria. Numerous tests have confirmed the effectiveness of UVC against molds, bacteria, and viruses. However, PCO units are not effective in removing particulates and VOCs.

While each type of portable room air purifier is effective for its intended purpose., there remains a need for an air purifier that will not only remove odors, dust, animal dander and other particulates, but also eliminate VOCs and destroy mold, bacteria and viruses that trigger allergy, asthma and infectious ailments in a safe, economical and efficient manner, without producing harmful ozone.

### SUMMARY OF THE INVENTION

The present invention overcomes the disadvantages of the prior art by providing a portable room air purifier that uses a three-stage purification process in a complementary manner to safely, effectively and economically clean air without producing harmful ozone.

In accordance with a first aspect of the present invention, a portable room air purifier includes a hollow cylindrical air filter contained within a housing and having a sorbent material disposed between an inner surface circumscribing a cylindrical air treatment space and an outer surface. A germicidal lamp is disposed within the cylindrical air treatment zone to emit germicidal radiation within the space and incident upon the sorbent material via the inner surface of the air filter. The inventive air purifier further includes a fan disposed in the housing to draw air from the cylindrical air treatment zone through the air filter such that the air enters the filter through the inner surface and exits the filter through the outer surface.

In an embodiment, the air filter includes a pleated filter material and the sorbent material is disposed on an inner surface of the pleated filter material facing the lamp. The germicidal lamp is preferably configured to emit a wavelength of light to reactivate or otherwise increase the effective life of the sorbent material. A mesh is preferably provided on an outer surface of the filter to provide structural support without causing unwanted reflection of the light emitted by the germicidal lamp.

In an embodiment, the germicidal lamp has a linear configuration and is disposed coaxial with a central longitudinal axis of the air filter and at least substantially the length thereof to illuminate substantially the whole inner surface of the air filter.

In an embodiment, the hollow cylindrical air filter has an open end that extends around one or more air intake openings formed in the housing. A shroud is preferably disposed proximate the open end of the air filter and configured to prevent radiation emitted by the lamp from exiting the air treatment space via the air intake openings. It is also preferred that the shroud have a configuration to divert air entering the air treatment space towards the inner surface of the air filter. Additionally, a surface of the shroud facing the lamp is preferably coated with a reflective material to cause germicidal light intercepted by the shroud to be reflected back into the air treatment space.

In an embodiment, the housing includes a base that elevates the air intake openings above a floor to create an air gap therebetween. The air filter preferably has a closed top and the housing is configured to hold the air filter in compression against the bottom of the housing so that air from the room is forced to flow through the air treatment space and the filter when the fan operates.

In an embodiment, the fan includes a blade assembly disposed within a hollow toroidal housing that shields users from the fan blades while allowing air to flow therethrough. The housing is preferably made up of upper and lower housing portions, with the fan disposed in the upper housing portion and the lamp/filter assembly disposed in the lower housing portion.

In an embodiment, the air purifier includes an electrical circuit configured to power the fan and the germicidal lamp when upper and lower housing portions are mated together and to deactivate both the fan and the lamp when the upper and lower housing portions are separated from one another. In an embodiment, the-electrical circuit includes first and second electrical connectors that mate with one another when the upper and lower housing portions are mated together. In an embodiment, the first and second electrical connectors each include two sets of contacts; however, the sets of contacts in the first connector can only be electrically connected through the second connector.

In an embodiment, the portable room air purifier also includes a resettable timing circuit that measures an amount of time that the unit is in operation and an indicator lamp responsive to the timing circuit to notify a user when at least one of the filter and the lamp are in need of replacement.

In accordance with a second aspect of the present invention, a method of purifying air in a room includes the steps of positioning a portable room air purifier in a room, drawing air from the room into a first air treatment zone bounded on at least one side by an air filter and containing a germicidal lamp, treating the air in the first air treatment zone by exposing the air to germicidal radiation emitted by the germicidal lamp, drawing air from the first air treatment zone into a second air treatment zone in the air filter containing activated carbon, drawing air from the second air treatment zone through a third air treatment zone in the air filter configured to remove particulates, and expelling the treated air from the room air purifier.

In an embodiment, the method also includes the step of reactivating the sorbent material by exposing the material to an effective amount of radiation from the germicidal lamp.

In another embodiment, the first air treatment zone is defined by placing a hollow cylindrical air filter with a closed top and an open bottom in a housing such that the open bottom forms a seal around one or more air intake openings formed in a bottom wall of the housing.

In an embodiment, the method also includes elevating the bottom wall of the housing above a floor of the room to allow air to be drawn in the first air treatment zone via the air intake openings. In a further embodiment, the step of drawing air into the first air treatment zone includes redirecting the flow of air from the room towards the first filter surface using a shroud. The shroud may also be used to perform a step of blocking radiation emitted by the lamp in the direction of the one or more air intake openings.

In an embodiment, the method also includes disabling power to the lamp and the filter when upper and lower housing portions are disassembled from one another.

Some of the advantages of the present invention over the prior art include reducing or eliminating symptoms of allergies, asthma or other maladies triggered by mold, pollen, dander, bacteria and other metabolic products while at the same time removing VOCs that create odors and reducing the spread of infectious diseases caused by bacteria, viruses and other pathogens, all without producing harmful ozone; increasing efficiency by creating and maintaining air tight seals between purification stages; reducing operating costs by increasing the useful life of filter components; and improving safety by preventing access to potentially harmful components during operation.

Other objects and advantages of the present invention will become apparent to those of skill in the art upon reviewing the detailed description of the preferred embodiment provided herein.

### BRIEF DESCRIPTION OF THE DRAWINGS

The accompanying drawings, which are incorporated herein and form part of the specification, illustrate a preferred embodiment of the present invention and, together with the detailed description, further serve to explain the principles of the invention and to enable a person skilled in the art to make and use the invention. In the drawings, like reference numbers are used to indicate identical or functionally similar elements.

FIG. 1 is an isometric view of a portable room air purifier according to an embodiment of the present invention.

FIG. 2 is a partial cut-away view of the portable room air purifier shown in FIG. 1.

FIG. 3 is an exploded view of the portable room air purifier shown in FIG. 1.

FIG. 4 is a schematic diagram of an interlock disconnect circuit for a portable room air purifier according to an embodiment of the present invention.

### DETAILED DESCRIPTION OF THE PREFERRED EMBODIMENT

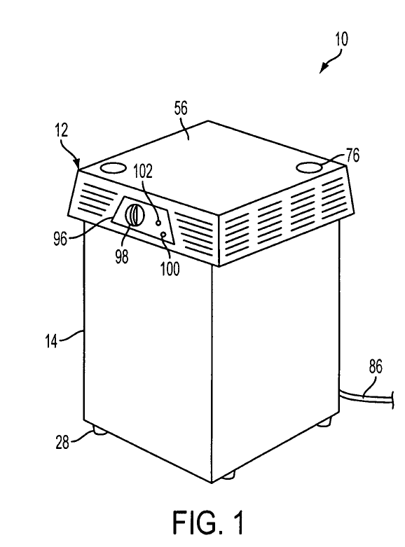

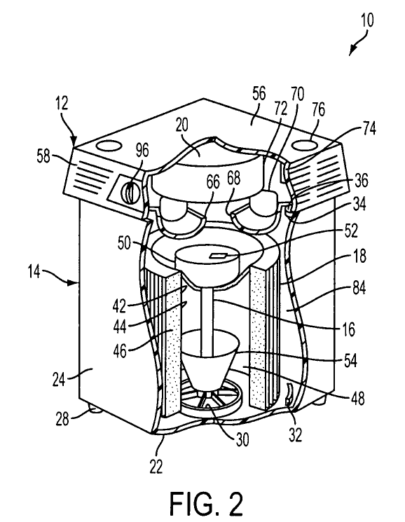

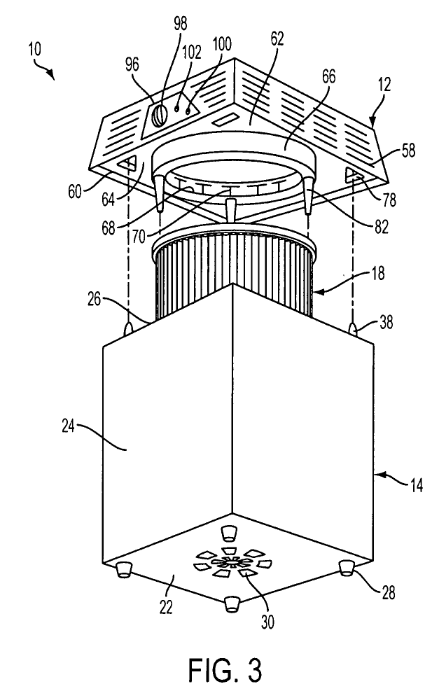

A portable room air purifier 10 according to an embodiment of the present invention is shown in FIGS. 1-4. The portable room air purifier 10 includes upper and lower housings 12 and 14. The lower housing 14 contains a germicidal lamp 16 disposed in relation to an air filter 18, and the upper housing 12 contains a fan 20 that draws air through the lower housing such that it is first sterilized by the lamp and then passed through the filter before being expelled from the portable room air purifier.

The lower housing 14 is configured as a free-standing unit having a bottom wall 22 and a plurality of side walls 24 that extend upwardly from the bottom wall to an open top 26. A base 28 is configured to support the bottom wall 22 of the housing 14 above the floor of a room so that air can flow through the space between the bottom wall and the floor. In the illustrated embodiment, the bottom wall 22 is generally square and includes a plurality of air intake vents or openings 30 formed therethrough to facilitate the flow of air from outside the apparatus into the lower housing 14. In a preferred embodiment, the air intake vents 30 are defined in a central circular region of the bottom wall 22 by a plurality of concentric circular rings and equiangularly spaced radial members. A circular rib or protrusion 32 on the inside surface of the bottom wall 22 circumscribes the air intake vents 30. Also in this embodiment, the base 28 includes a plurality of feet that extend downwardly from corners of the bottom wall 22 so that the bottom wall is elevated above the floor when the lower housing 14 is placed in an upright portion on the floor.

In the illustrated embodiment, the side walls 24 of the lower housing 14 are generally rectangular with vertical edges that intersect at right angles to define an interior air treatment space of generally square configuration in horizontal cross-section. A rim or lip 34 extends inwardly from upper edges of the sidewall to define a large circular opening 36 at the top of the lower housing. A pair of posts or pins 38 extend upwardly from the rim 34 at diametrically opposed sides of the circular opening 36. The posts 38 are of generally conical configuration, with a threaded receptacle formed at the terminal end of each post. A recess of generally conical configuration may also be formed in the rim adjacent another corner of the lower housing top.

The air filter 18 is of hollow cylindrical configuration with inner and outer surfaces 42 and 44 and a sorbant material 46 disposed on the inner surface. The outer surface 44 of the air filter 18 has a diameter smaller than the diameter of the opening 36 at the top of the lower housing 14, and the axial length of the air filter is less than the height of the lower housing sidewalls 24, to define an air outlet plenum in the space around the air filter when it is placed in the lower housing. The inner surface 42 of the air filter 18 defines a cylindrical air treatment space 48. The air filter 18 sits on the bottom wall 22 within the lower housing 14 in a vertical orientation such that the air intake vents or openings 30 in the bottom wall are contained within a region of the wall aligned with the cylindrical air treatment space 48 defined by the inner surface 42 of the air filter. A bottom portion of the air filter 18 is open and fits telescopically inside the circular rib 32 on the bottom wall 22 of the lower housing 14 to assist in aligning the air filter with the air intake openings 30.

In a preferred embodiment, the inner surface 42 of the air filter 18 is defined by a pleated filter material and the outer surface 44 of the air filter is defined by an air permeable, cylindrical support member. An inwardly-facing surface of the pleated filter material is preferably coated with the sorbent material 46 (e.g., activated carbon) such that the sorbent material is on a side of the pleated material facing the germicidal lamp. The cylindrical support member forming the outer surface 44 of the air filter is preferably formed of a wire mesh material with relatively large openings (e.g., 0.375×0.75 diamond shaped openings) that provides axial support for the air filter without interfering with air flow through the filter. Positioning the support member outside the filter material also eliminates unwanted reflection of germicidal light that could otherwise escape the unit and pose a hazard. Preferably, the open bottom portion of the air filter 18 is provided with a gasket ring to create an air tight seal between the bottom of the air filter and the lower housing 14.

The top of the air filter 18 is covered by a lamp fixture 50 including a germicidal lamp 16 suspended in the cylindrical space 48 defined by the inner surface 42 of the air filter to illuminate the space and the inner surface of the air filter. The lamp 16 is preferably linear and arranged concentric with a central longitudinal axis of the filter 18 to provide substantially uniform radiation about the entire inner circumference of the air filter 18. Preferably, the lamp 16 extends substantially the height of the filter 18 so that substantially all of the inner surface 42 of the air filter is illuminated by the lamp. The germicidal lamp 16 includes a germicidal tube coupled to and carried by a base. For the present application, the germicidal lamps sold by the assignee of this invention, Steril-Aire U.S.A., Inc, are preferred. The base is integrated with the fixture 50 and contains electrical circuitry and ballast for energizing the germicidal tube to emit ultraviolet radiation, preferably in the “C” band (UVC). In a preferred embodiment, the lamp 16 generates about 1600 microwatts per square centimeter at the inner surface of the air filter.

The lamp fixture 50 sits horizontally across the top of the air filter 18 and includes an electrical connector 52. The fixture 50 seals the top of the air filter 18 to prevent air from leaking out of the cylindrical space 48 without passing through the air filter.

A shroud or shield 54 formed of an optically opaque or UVC-blocking material is mounted on the bottom wall 22 of the lower housing 14 beneath the lamp 16 to direct air into the cylindrical space 48 and, at the same time, to prevent UVC radiation from escaping the portable room air purifier. Preferably, the shroud 54 is configured as a hollow, inverted conical frustum with a central longitudinal axis coaxial with a longitudinal axis of the lamp 16. The concave side of the shroud 54 faces the lamp 16, and the height and width of the shroud are such that radiation from the lamp is blocked by the shroud and prevented from radiating through the air intake vents 30. This design has an added advantage of diverting air flow around the terminal end of the lamp 16, where light output is the lowest, into the most highly irradiated portions of the cylindrical space along the length of the lamp so that exposure of airborne pathogens to the germicidal radiation is maximized. In a preferred embodiment, an inner surface of the frustoconical shroud 54 facing upwardly toward the lamp 16 is coated with a material that reflects UVC radiation to improve performance and reduce losses. The vent openings 30 in the bottom wall of the housing 14 are preferably disposed in an annular region between the shroud 54 and the inner surface of the air filter 18 so that air can be drawn into the cylindrical space 48 around the shroud and be illuminated, and thus sterilized, by the lamp before passing through the air filter.

The upper housing 12 is configured to mate with the lower housing 14 such that the upper and lower housings cooperate to promote air flow through multiple air-purifying stages of the portable room air purifier. The upper housing 12 is generally trapezoidal in vertical cross-section, with a square top 56 and generally rectangular sidewalls 58 that extend downwardly from peripheral edges of the top with a slightly outward taper to an open bottom 60 that fits around the open top 26 of the lower housing 14. A bottom wall 62 of the upper housing includes a flat, recessed portion 64 that extends horizontally inward from the sidewalls to a hollow toroidal portion 66 that extends downwardly from the flat portion and includes an open center 68 of circular configuration. The fan 20 includes a fan blade assembly 70 disposed within the hollow toroidal portion 66 and connected to a fan motor 72 disposed within the upper housing 12. The fan 20 is preferably a variable speed fan capable of moving up to 250 cfm (cubic feet per minute) or 7.08 cmm (cubic meters per minute).

A pair of captive bolts 74 extend through the upper housing 12 in alignment with the threaded openings formed in the lower housing posts 38 to draw the housings together. The bolt heads 76 are accessible from the top of the housing and configured to be turned by hand. The threaded shafts of the bolts terminate in bolt recesses 78 formed in the flat portion of the upper housing 12 in opposed relation to the posts 38 extending upward from the lower housing 14. The bolt recesses are preferably conical in configuration with a relatively wide mouth and tapered sides that cause the recess to narrow along its length to capture and guide the posts 38 to the bolts during assembly of the upper and lower housings 12 and 14. Similarly, an optional post or pin may optionally extend downwardly from the flat portion 64 of the housing bottom 62 in opposed relation to a conical recess formed in the lower housing rim 34.

A plurality of feet 82 extend downwardly from the upper housing 12 towards the lamp fixture 50 and are of sufficient length to exert downward pressure on the fixture when the bolts 74 are tightened so that the gasket material between the air filter 18 and the bottom of the lower housing 14 is compressed, thereby establishing an air tight seal that divides the space within the lower housing into a cylindrical air treatment space 48 within the air filter and an air output plenum 84 in the space between the air filter 18 and the side walls 24 of the lower housing. The feet 82 are preferably mounted on the bottom surface of the hollow toroidal wall 66 extending around the bottom of the upper housing. Preferably, the toroidal wall 66 is configured to extend downwardly from the upper housing 12 through the circular opening 36 at the top of the lower housing 14 to position the fan opening 68 slightly above the air filter assembly so that an air tight seal is not required between the upper and lower housing.

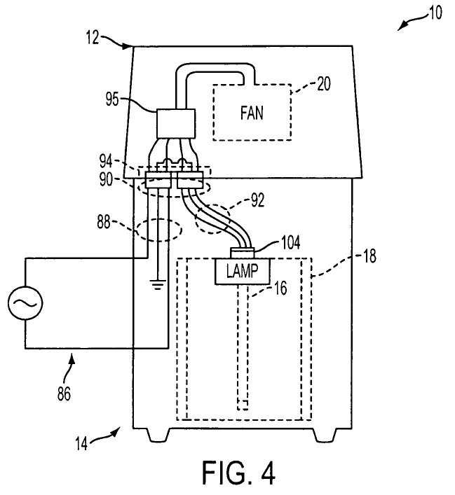

The portable room air purifier 10 includes a standard AC power cord 86 that extends from the lower housing 14. As shown in FIG. 4, the power cord 86 is electrically connected to a first set of wires 88 that run upwardly through the lower housing 14 to a first connector 90 disposed adjacent the open top 26 of the lower housing. The first set of wires 88 from the power cord 86 are connected to a first set of contacts in the first connector 90. A second set of wires 92 extend from a second set of contacts in the first connector 90 to the lamp fixture 50; however, the first and second sets of contacts in the first connector 90 do not make electrical contact with one another. A second connector 94 disposed in the upper housing 12 in opposed relation to the first connector 90 includes third and fourth sets of contacts that mate with the first and second sets of contacts in the first connector when the upper and lower housings are assembled together. Power from the first set of contacts in the first connector 90 is fed to an on/off switch via the third set of contacts in the second connector 94 and is then fed to a power circuit 95. The power circuit powers the fan 20 and, via the second set of contacts in the first connector, the lamp 16. An advantage of this power supply arrangement is that power to both the fan 20 and the lamp 16 is interrupted when the upper housing 12 is disassembled from the lower housing 14, thereby preventing injury to users that can be caused by physical exposure to the rotating fan blade assembly 70 or emissions from the germicidal lamp 16. In a preferred embodiment, the contacts in the first and second electrical connectors 90 and 94 are recessed so as to prevent a user from touching the contacts.

The upper housing 12 also includes a control panel 96 having a knob 98 connected to an electrical circuit for controlling the speed of the fan 20, an indicator light 102 connected to a circuit that keeps track of in-service time of the current filter/lamp unit, and a reset button 100 connected to the timing circuit to reset the time to zero when a new filter/lamp unit is installed. The indicator light 102 is preferably an LED capable of changing color as the filter/lamp unit approaches the end of its effective life.

To assemble the portable room air purifier 10, the filter 18 is positioned in the lower housing 14 in a vertical orientation so as to define a central cylindrical space 48 above the air intake vents 30 in the bottom of the housing. Preferably, the lamp 16 is pre-assembled with the filter 18 as a unit such that, when the filter is placed in the lower housing 14, the lamp is arranged concentric with the filter within the cylindrical space 48 and above the lamp shroud 54 at the bottom of the unit. The lamp 16 is connected to the power circuit by inserting the plug 104 from the lower housing connector 90 into the receptacle 52 formed at the top of the filter and lamp assembly. The upper housing 12 is then placed on the lower housing 14 with the feet 82 on the bottom of the upper housing arranged to sit on top of the air filter 18 and the electrical connectors 90 and 94 in the upper and lower housings mating with one another. The bolts 74 on the top of the housing are tightened, causing the feet 82 to press downwardly on the lamp fixture 50 so that the air filter 18 (and the gasket material at the top and bottom of the air filter) are held in compression between the upper and lower housings, creating an air tight seal with the housing. With the electrical connectors 90 and 94 mated with one another, AC power from the wall outlet is routed to the electrical circuit in the upper housing 12 via the connector 90 in the lower housing 14 and to the lamp 16 in the lower housing 14 via the electrical circuit in the upper housing 12.

In use, the air purifier 10 is positioned in a room, preferably at least six inches from a wall or furniture, on a level floor that allows air to freely flow into the bottom of the unit. The air purifier 10 is plugged into the nearest wall outlet, and the fan control knob 98 on the front of the unit is turned to a desired speed setting to cause the fan 20 to operate. The lamp 16 is also powered at this time. The fan 20 creates a vacuum in the space between the outer surface of the air filter 18 and the lower housing 14 so that air is drawn into the unit via the air intake openings 30 in the bottom of the housing. The air flows around the shroud 54 into the cylindrical space 48 inside the air filter 18, which comprises the first stage of the unit. The air drawn into the cylindrical space 48 is irradiated by UVC light generated by the germicidal lamp 16. The UVC light destroys biological contaminants, such as bacteria, viruses, and mold spores, that are present in the air. The UVC light also illuminates the inner surface 42 of the air filter 18, which transmits the light to the sorbent material 46, constituting the second purifying stage of the unit. Reactivation of a sorption medium using UVC light is described in greater detail in commonly-owned U.S. Pat. No. 6,423,882, which is incorporated herein by reference.

The sterilized air from the first stage is then drawn into the air filter 18 where, in the second stage of the purification process, VOCs and odors are adsorbed by the sorbent material 46. The air then passes through the third stage of the process, in which the pleated filter material 44 captures particles, preferably as small as 0.3 micron with about 95% efficiency. The three-stage purified air is then drawn into the toroidal fan housing 66 via opening 68 and expelled from the top of the unit.

After a period of continuous operation, the filter unit will no longer perform at optimal efficiency. In general, the filter unit should be replaced at least once a year (or approximately every 9000 hours of continuous operation) to ensure maximum effectiveness and protection from irritants and pollutants. The actual time frame will depend upon the actual use and conditions in the room.

During the first 7500 hours (about 8-9 months) the indicator light 102 on the control panel 96 is preferably green. During the next 1500 hours (about 2-3 months) the same light 102 will preferably turn yellow indicating that it is time to order a filter unit replacement. At about 9000 hours (about 1 year), the light 102 preferably becomes red indicating that it is time to change the filter unit replacement. After replacing the filter unit (which preferably includes the lamp), the reset button 100 is pressed to reset the timing circuit.

While a preferred embodiment of the invention has been described above, it will be appreciated that various modifications can be made by those of skill in the art without departing from the spirit and scope of the present invention. For example, while the housing has been shown as a generally polygonal structure with a plurality of side walls of generally rectangular configuration, it will be appreciated that the housing can have any suitable configuration, including but not limited to cylindrical, frustoconical, or other configurations. Similarly, the number, shape and arrangement of the air intake and exhaust openings can be varied, e.g., to include one or more holes or slots or some combination of the foregoing. The fan can be disposed above or below the air filter. The air filter is preferably a hollow cylindrical filter as shown, but can have any tubular configuration, including but not limited to elliptical or polygonal configurations in cross-section. Alternatively, a curved or flat panel filter may be used instead of a tubular filter. While a cylindrical mesh is described to impart structural support for the filter, it will be appreciated that other forms of support can be used, including but not limited to axial rods, perforated walls, etc.

While the air purifier is shown with one germicidal lamp disposed concentrically within a cylindrical air filter, it will be appreciated that more than one lamp can be positioned in relation to the air filter if desired. Although a single-ended linear germicidal lamp is preferred, the lamp can be u-shaped, j-shaped or have any other configuration suitable for destroying airborne pathogens, including double-ended designs. In an alternate embodiment, the flow of air can be reversed, in which case a ring-shaped lamp can be positioned around a tubular air filter in opposed relation to an outer surface of the filter containing activated carbon, and the air can be drawn from outside the filter into a central air exhaust space. Furthermore, other types of lamp status indicators can be used, including but not limited to the lamp status indicator disclosed in commonly-owned U.S. Pat. No. 7,238,326, the disclosure of which is incorporated herein by reference.

All of the foregoing changes, modifications and alterations should be considered within the scope of the present invention as set forth in the appended claims.

What is claimed is:

1. A portable room air purifier comprising:
a housing;
a hollow cylindrical air filter disposed within said housing, said air filter having an inner surface circumscribing a cylindrical air treatment space and an outer surface, and wherein a sorbant material is disposed on said inner surface of said air filter;
a germicidal lamp disposed within said cylindrical air treatment space to emit germicidal light within said space and incident upon said sorbant material on said inner surface of said air filter; and
a fan disposed in said housing to draw air from said cylindrical air treatment space through said air filter such that the air enters the filter through the inner surface and exits the filter through the outer surface.

2. The portable room air purifier of claim 1, wherein said air filter includes a pleated filter material and wherein said sorbent material is disposed on an inner surface of said pleated filter material facing said lamp.

3. The portable room air purifier of claim 2, wherein said outer surface of said air filter is defined by a mesh with openings that provides structural support for the filter without reflecting germicidal light emitted by said germicidal lamp.

4. The portable room air purifier of claim 1, wherein said germicidal lamp is configured to emit wavelengths of light to reactivate said sorbant material.

5. The portable room air purifier of claim 1, wherein said air filter has a central longitudinal axis and wherein said germicidal lamp is a linear germicidal lamp disposed coaxial with said central longitudinal axis of said air filter.

6. The portable room air purifier of claim 5, wherein said air filter has a length in a longitudinal direction and wherein said germicidal lamp extends approximately the length of said air filter.

7. The portable room air purifier of claim 1, wherein said housing has one or more air intake openings formed therein and wherein said hollow cylindrical air filter is configured with an open end that extends around said air intake openings to permit air to flow freely into said air treatment space.

8. The portable room air purifier of claim 7, further comprising a shroud disposed proximate said open end of said air filter.

9. The portable room air purifier of claim 1, wherein said shroud is configured to prevent radiation emitted by said lamp from exiting the cavity through said one or more air intake openings.

10. The portable room air purifier of claim 9, wherein said shroud is further configured to divert air entering said air treatment cavity through said one or more air intake openings towards said inner surface of said air filter.

11. The portable room air purifier of claim 9, wherein said shroud is a hollow frustoconical member axially aligned with said germicidal lamp.

12. The portable room air purifier of claim 9, wherein said shroud includes a concave surface oriented to face said germicidal lamp.

13. The portable room air purifier of claim 12, wherein said concave surface of said shroud is configured to reflect radiation from said germicidal lamp towards said air treatment space.

14. The portable room air purifier of claim 7, wherein said housing includes a base that elevates said one or more air intake openings above a floor to create an air gap therebetween.

15. The portable room air purifier of claim 1, wherein a top of said air filter is closed and wherein said fan is disposed above said air filter.

16. The portable room air purifier of claim 15, wherein said housing includes a lower portion containing said air filter and an upper portion containing said fan, said upper and lower housing portions being configured to removably mate with one another.

17. The portable room air purifier of claim 16, wherein said upper portion includes one or more protrusions that extend downwardly from said upper portion to place said air filter in compression when said upper portion is mated with said bottom portion.

18. The portable room air purifier of claim 17, wherein a top of said air filter is closed.

19. The portable room air purifier of claim 17, wherein said upper housing portion includes a toroidal fan housing with an inner annular opening and wherein said fan includes a blade assembly rotatably disposed within said toroidal fan housing.

20. The portable room air purifier of claim 19, wherein said toroidal fan housing extends into said lower housing portion when said upper and lower housing portions are mated together.

21. The portable room air purifier of claim 16, further comprising an electrical circuit powering said fan and said germicidal lamp, wherein said electrical circuit is configured to deactivate both the fan and the lamp when said upper and lower portions of said housing are separated from one another.

22. The portable room air purifier of claim 21, wherein said electrical circuit includes first and second electrical connectors that mate with one another when said upper and lower housing portions are mated together.

23. The portable room air purifier of claim 22, wherein said first and second electrical connectors each include two sets of contacts, and wherein the sets of contacts in said first connector are electrically connected through said second connector.

24. The portable room air purifier of claim 1, further comprising a timing circuit that measures an amount of time that said portable room air purifier is in operation and an indicator lamp responsive to said timing circuit to notify a user when at least one of said filter and said lamp are in need of replacement.

25. The portable room air purifier of claim 24, further comprising a reset button, wherein said timing circuit is configured to restart a time measurement in response to operation of said reset button.

26. A method of purifying air in a room, said method comprising:
positioning a portable room air purifier in a room;
drawing air from the room into a first air treatment zone bounded on at least one side by an air filter and containing a germicidal lamp;
treating the air in the first air treatment zone by exposing the air to germicidal radiation emitted by the germicidal lamp;
drawing air from the first air treatment zone into a second air treatment zone in the air filter containing activated carbon;
drawing air from the second air treatment zone through a third air treatment zone in the air filter configured to remove particulates; and
expelling the treated air from the room air purifier.

27. The method of claim 26, further comprising the step of reactivating the carbon in the second air treatment zone by exposing the carbon to an effective amount of radiation from the germicidal lamp.

28. The method of claim 26, further comprising the step of defining the first air treatment zone by placing a hollow cylindrical air filter with a closed top and an open bottom in a housing such that the open bottom sits on a bottom wall of the housing.

29. The method of claim 28, wherein said step of defining the first air treatment zone further includes positioning the open bottom of the air filter over one or more air intake openings formed in the bottom wall of the housing.

30. The method of claim 29, wherein said step of defining the first air treatment zone further includes elevating the bottom wall of the housing above a floor of the room to allow air to be drawn into the first air treatment zone via the air intake openings.

31. The method of claim 29, wherein said step of defining the first air treatment zone further includes compressing the hollow cylindrical air filter against the bottom wall of the housing.

32. The method of claim 29, wherein said drawing steps are performed by a fan disposed in an upper portion of the housing and wherein said compressing step includes mating the upper portion of the housing with a lower portion of the housing such that protrusions on the upper portion of the housing engage the top of the air filter.

33. The method of claim 26, wherein said step of drawing air into the first air treatment zone includes redirecting the flow of air from the room towards the first filter surface using a shroud.

34. The method of claim 33, wherein one or more air intake openings are formed in a bottom of the housing and further comprising the step of blocking radiation emitted by the lamp in the direction of the one or more air intake openings using the shroud.

35. The method of claim 26, wherein the portable room air purifier includes upper and lower housings, with a fan disposed in the upper housing and the lamp and filter disposed in the lower housing, and further comprising the step of disabling power to the fan and the lamp when the upper housing is removed from the lower housing.

36. The method of claim 35, wherein said disabling step includes routing power to the fan and the lamp via a single electrical connector assembly with first and second connectors disposed on the upper and lower housings and configured to mate with one another and establish electrical connections when the upper and lower housings are assembled together.
